(19) United States
(12) Patent Application Publication
(10) Pub. No.: US 2025/0015358 A1
(43) Pub. Date: Jan. 9, 2025

(54) BATTERY

(71) Applicant: MURATA MANUFACTURING CO., LTD., Kyoto (JP)

(72) Inventors: Rie TAKEMIYA, Kyoto (JP); Masayuki IWAMA, Kyoto (JP)

(21) Appl. No.: 18/896,398

(22) Filed: Sep. 25, 2024

Related U.S. Application Data
(63) Continuation of application No. PCT/JP2023/009934, filed on Mar. 14, 2023.

(30) Foreign Application Priority Data
Mar. 30, 2022 (JP) 2022-057218

(51) Int. Cl. H01M 10/0569; H01M 10/0525; H01M 10/0568; H01M 10/0587

(52) U.S. Cl. CPC H01M 10/0569; H01M 10/0525; H01M 10/0568; H01M 10/0587; H01M 2300/0034; H01M 2300/0042

(57) ABSTRACT

Provided is a battery having excellent cycle characteristics in a low temperature environment. A battery includes components housed in an exterior can, the components including: an electrode wound body having a structure in which a band-shaped positive electrode including a positive-electrode foil and a positive-electrode active material layer and a band-shaped negative electrode including a negative-electrode foil and a negative-electrode active material layer are stacked with a separator interposed therebetween and wound around a central axis; a positive-electrode current collecting plate; a negative-electrode current collecting plate; and an electrolytic solution, in which the electrode foil has an electrode active material covered portion covered with the active material layer and an active material non-covered portion not covered with the active material layer, a surface on which the active material non-covered portion bent toward the central axis overlaps and the current collecting plate are bonded to each other, and the electrolytic solution contains 7.7 mass % or more and 11.5 mass % or less of fluoroethylene carbonate, 0.032 mass % or more and 0.048 mass % or less of lithium tetrafluoroborate, and lithium hexafluorophosphate.

### CROSS REFERENCE TO RELATED APPLICATIONS

The present application is a continuation of PCT patent application no. PCT/JP2023/009934, filed on Mar. 14, 2023, which claims priority to Japanese patent application no. 2022-057218, filed on Mar. 30, 2022, the entire contents of which are incorporated herein by reference.

### BACKGROUND

The present disclosure relates to a battery.

A battery is provided and including an electrode wound body in which a band-shaped positive electrode and a band-shaped negative electrode are stacked with a separator interposed therebetween and wound, in which the positive electrode and the negative electrode have a non-covered portion that is not covered with an active material layer. Here, the non-covered portion is bonded to a current collecting plate at an end portion of the electrode wound body, and is bent toward a central axis of the wound structure and overlaps with the current collecting plate.

A secondary battery is provided, when the content of fluoroethylene carbonate (FEC) in a solvent of a nonaqueous electrolytic solution is 2 to 50 vol % and the content of lithium tetrafluoroborate (LiBF₄) is 0.1 to 1.0 mol/liter, cycle characteristics can be improved by suppressing precipitation of metallic lithium generated on the surface of a negative electrode by the action of FEC, and decomposition of FEC during charge storage can be suppressed by the action of LiBF₄, so that generation of gas associated with decomposition can be suppressed.

### SUMMARY

The present disclosure relates to a battery.

However, since the battery having the structure as described in the Background section has a small battery resistance, heat generation during charge and discharge is small. Therefore, when the composition of the electrolytic solution is the composition described in the Background section, precipitation of metallic lithium generated on the surface of the negative electrode in a low temperature environment cannot be sufficiently suppressed, and the cycle characteristics in a low temperature environment may be deteriorated.

The present disclosure, in an embodiment, relates to providing a battery having excellent cycle characteristics in a low temperature environment.

According to the present disclosure in an embodiment, a battery includes components housed in an exterior can, the components including: an electrode wound body having a structure in which a band-shaped positive electrode including a positive-electrode foil and a positive-electrode active material layer and a band-shaped negative electrode including a negative-electrode foil and a negative-electrode active material layer are stacked with a separator interposed therebetween and wound around a central axis; a positive-electrode current collecting plate; a negative-electrode current collecting plate; and an electrolytic solution, in which the positive-electrode foil has a positive-electrode active material covered portion covered with the positive-electrode active material layer and a positive-electrode active material non-covered portion not covered with the positive-electrode active material layer, the negative-electrode foil includes a negative-electrode active material covered portion covered with the negative-electrode active material layer and a negative-electrode active material non-covered portion not covered with the negative-electrode active material layer, a surface on which the positive-electrode active material non-covered portion bent toward the central axis overlaps and the positive-electrode current collecting plate are bonded to each other, a surface on which the negative-electrode active material non-covered portion bent toward the central axis overlaps and the negative-electrode current collecting plate are bonded to each other, and the electrolytic solution contains 7.7 mass % or more and 11.5 mass % or less of fluoroethylene carbonate, 0.032 mass % or more and 0.048 mass % or less of lithium tetrafluoroborate, and lithium hexafluorophosphate.

According to the present disclosure in an embodiment, a battery having excellent cycle characteristics in a low temperature environment can be provided.

### BRIEF DESCRIPTION OF THE FIGURES

FIG. 1 is a schematic sectional view of a battery according to an embodiment.

FIG. 2 is a diagram illustrating an example of a structure before winding of an electrode wound body of the battery according to an embodiment.

FIG. 3 is a plan view illustrating an end portion of the battery according to an embodiment.

FIG. 4 is a diagram illustrating an example of a section taken along line IV-IV in FIG. 3.

FIG. 5A is a diagram illustrating a positive-electrode current collecting plate of the battery according to an embodiment.

FIG. 5B is a diagram illustrating a negative-electrode current collecting plate of the battery according to an embodiment.

### DETAILED DESCRIPTION

The present disclosure will be described in further detail according to an embodiment. The present disclosure is not limited thereto.

In an embodiment, a cylindrical lithium ion battery will be described as an example of the battery. The battery according to the present disclosure is not limited thereto, and any battery other than the lithium ion battery or a battery that has any shape other than the cylindrical shape may be used.

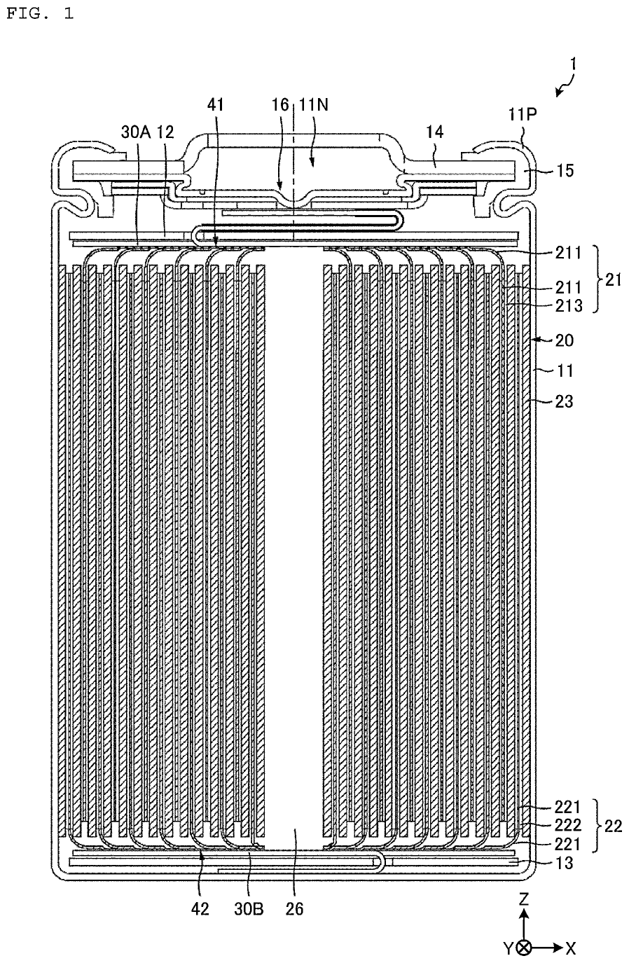

FIG. 1 is a schematic sectional view of a battery according to a present embodiment. A battery 1 according to the present embodiment is, for example, a cylindrical lithium ion battery as illustrated in FIG. 1. The battery 1 includes an exterior can 11, insulating plates 12 and 13, a battery lid 14, a gasket 15, an electrode wound body 20, and a safety valve mechanism 16. The battery 1 has a structure in which insulating plates 12 and 13, an electrode wound body 20, a safety valve mechanism 16, a positive-electrode current collecting plate 30A, and a negative-electrode current collecting plate 30B are housed in a space sealed by an exterior can 11, a battery lid 14, and a gasket 15, and are filled with an electrolytic solution. The configuration of the battery 1 is not limited thereto, and for example, a positive temperature coefficient (PTC) element, a reinforcing member, and the like may be further provided inside the exterior can 11.

The exterior can 11 is a member that houses the electrode wound body 20 or the like. The exterior can 11 is a cylindrical container in which one end portion is opened in a Z direction and the other end portion is closed. That is, the exterior can 11 has an open end portion (open end portion 11N). The exterior can 11 is, for example, a metal such as iron or aluminum, or an alloy. A surface of the exterior can 11 may be plated with metal such as nickel.

Here, in the exterior can 11, a crimped structure 11R is formed at an open end portion 11N. The crimped structure 11R crimps the battery lid 14 and the safety valve mechanism 16 with the gasket 15 interposed therebetween. The crimped structure 11R is a so-called crimp structure. Thus, the inside of the exterior can 11 is hermetically sealed.

The battery lid 14 is a member that closes the open end portion 11N of the exterior can 11. In the battery lid 14, a region around the central axis of the battery 1 protrudes in a +Z direction with respect to an XY plane. A region other than the protruding region of the battery lid 14 is in contact with the safety valve mechanism 16. Thus, the battery lid 14 is electrically connected to the safety valve mechanism 16. The battery lid 14 contains, for example, the same material as the material for forming the exterior can 11.

The gasket 15 is a member that seals a gap between a bent portion 11P and the battery lid 14. The gasket 15 is electrically insulated and contains an insulating material. As a result, the gap between the bent portion 11P and the battery lid 14 is sufficiently sealed, and direct contact between the exterior can 11 and the battery lid 14 can be prevented. The kind of the insulating material is not particularly limited, and is, for example, a polymer material such as polybutylene terephthalate (PBT) and polypropylene (PP), and is preferably polybutylene terephthalate. A surface of the gasket 15 may be covered with asphalt for example.

The safety valve mechanism 16 is a mechanism for preventing battery rupture. The safety valve mechanism 16 has a protrusion in a −Z direction, and the protrusion of the safety valve mechanism 16 is in contact with a connection portion 32B of a positive-electrode current collecting plate 30A described later. Accordingly, the safety valve mechanism 16 is electrically connected to the positive-electrode current collecting plate 30A. When the pressure (internal pressure) inside the exterior can 11 increases due to the generation of the gas, the safety valve mechanism 16 is deformed in the +Z direction to disconnect the connection with the positive-electrode current collecting plate 30A and cut off the current. In this state, when the internal pressure of the exterior can 11 further increases, the safety valve mechanism 16 cleaves itself to release the sealed state of the exterior can 11, thereby releasing the internal pressure. Thus, the battery 1 can be prevented from being ruptured by the gas.

The insulating plates 12 and 13 are dish-shaped plates that each have a thickness in the Z direction and a surface substantially perpendicular to the winding axis of the electrode wound body 20. The insulating plate 12 is provided in the +Z direction of the electrode wound body 20, and the insulating plate 13 is provided in the −Z direction of the electrode wound body 20. That is, the insulating plates 12 and 13 are arranged to sandwich the electrode wound body 20 therebetween. The insulating plate 12 is provided with a slit through which a band-shaped portion 32 of the positive-electrode current collecting plate 30A passes. Similarly, the insulating plate 13 is provided with a slit through which a band-shaped portion 34 of the negative-electrode current collecting plate 30B passes.

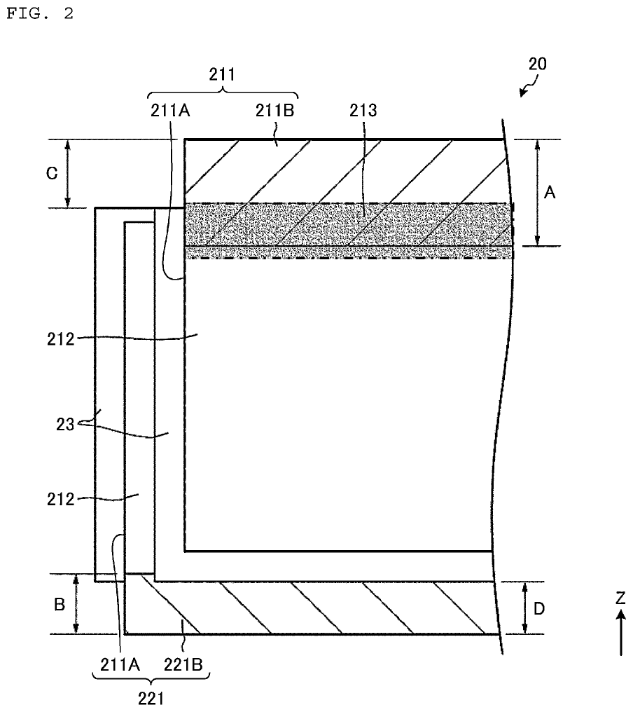

FIG. 2 is a schematic view illustrating constituent members of an electrode wound body of the battery according to the present embodiment. The electrode wound body 20 includes a positive electrode 21, a negative electrode 22, and a separator 23. In the electrode wound body 20, a laminate in which the positive electrode 21 and the negative electrode 22 sandwich the separator 23 as illustrated in FIG. 2 is spirally wound. Here, in the laminate in which the separator 23 is sandwiched between the positive electrode 21 and the negative electrode 22 of the electrode wound body 20, the electrode wound body 20 having the end portions 41 and 42 parallel to the XY plane in the Z direction is housed in the exterior can 11 and impregnated with the electrolytic solution.

The central axis of the electrode wound body 20 is a hole penetrating therethrough. That is, the electrode wound body 20 is provided with a through hole 26. The through hole 26 is a hole into which a winding core for assembling the electrode wound body 20 and an electrode rod for welding are inserted. In the example according to the present embodiment, the through hole 26 is provided with a center pin (not illustrated). The center pin is made of metal.

The positive electrode 21 is a belt-shaped member including a positive-electrode foil 211, a positive-electrode active material layer 212, and an insulating layer 213. The material of the positive-electrode foil 211 is, for example, a metal foil containing aluminum or an aluminum alloy, and is an aluminum foil in the example shown in the present embodiment.

The positive-electrode active material layer 212 is a layer containing a positive-electrode active material. The positive-electrode active material layer 212 is provided on one surface or both surfaces of the positive-electrode foil 211. As illustrated in FIG. 2, the positive-electrode active material layer 212 covers most of the positive-electrode foil 211, but does not cover the periphery of one end (end in the +Z direction) in the minor axis direction of the band. Here, a portion of the positive-electrode foil 211 covered with the positive-electrode active material layer 212 is a positive-electrode active material covered portion 211A, and a portion of the positive-electrode foil 211 not covered with the positive-electrode active material layer 212 is a positive-electrode active material non-covered portion 211B. The positive-electrode foil 211 includes the positive-electrode active material covered portion 211A and the positive-electrode active material non-covered portion 211B.

The positive-electrode active material layer 212 contain a positive-electrode active material capable of occluding and releasing lithium. The positive electrode material is preferably a lithium-containing compound, and more specifically, is preferably a lithium-containing composite oxide, a lithium-containing phosphate compound, or the like. The lithium-containing composite oxide is an oxide containing lithium and one or more elements other than lithium as constituent elements. The lithium-containing composite oxide has, for example, a layered rock salt-type or spinel-type crystal structure. The lithium-containing phosphate compound is a phosphate compound containing lithium and one or more elements other than lithium as constituent elements, and has, for example, an olivine type crystal structure.

The positive-electrode active material layer 212 may further include a positive electrode binder. The positive electrode binder includes any one or more of synthetic rubbers and polymer compounds, for example. Examples of the synthetic rubber include styrene-butadiene-based rubber, fluorine-based rubber, and ethylene propylene diene. Examples of the polymer compounds include a polyvinylidene fluoride and a polyimide.

A positive-electrode active material layer 212 may further include a positive-electrode conductive agent. The positive-electrode conductive agent may be any material, and contains, for example, carbon. Examples of the carbon include graphite, carbon black, acetylene black, and Ketjen black. Here, the positive-electrode conductive agent is not limited thereto, and may be a metal material, a conductive polymer, or the like as long as the agent is a conductive material.

The insulating layer 213 is stacked in a section with a width of 3 mm including a boundary between the positive-electrode active material non-covered portion 211B and the positive-electrode active material layer 212. The insulating layer 213 is stacked on the entire surface of the positive-electrode active material non-covered portion 211B on the separator 23 side. As described above, by providing the insulating layer 213, when a foreign matter enters between the negative-electrode active material layer 222 and the positive-electrode active material non-covered portion 211B, the battery 1 can be prevented from being short-circuited, and when an impact is applied to the battery 1, the impact is absorbed, and bending of the positive-electrode active material non-covered portion 211B and a short circuit with the negative electrode 22 can be prevented.

The negative electrode 22 is a band-shaped member including a negative-electrode foil 221 and the negative-electrode active material layer 222.

The material of the negative-electrode foil 221 is, for example, a metal foil containing nickel, a nickel alloy, copper, or a copper alloy, and is a copper foil in the example described in the present embodiment. The surface of the negative-electrode foil 221 is roughened at least in a region in contact with the negative-electrode active material layer 222. The roughening is performed, for example, by forming fine particles on the surface of the negative-electrode foil 221 by an electrolytic treatment method. This makes it possible to improve the adhesion of the negative-electrode active material layer 222 with respect to the negative-electrode foil 221 by a so-called anchor effect.

The negative-electrode active material layer 222 is a layer containing a negative-electrode active material. The negative-electrode active material layer 222 is provided on one surface or both surfaces of the negative-electrode foil 221. As illustrated in FIG. 2, the negative-electrode active material layer 222 covers most of the negative-electrode foil 221, but does not cover the periphery of the other end (end in the −Z direction) in the minor axis direction of the band. Here, a portion of the negative-electrode foil 221 covered with the negative-electrode active material layer 222 is a negative-electrode active material covered portion 221A, and a portion of the negative-electrode foil 221 not covered with the negative-electrode active material layer 222 is a negative-electrode active material non-covered portion 221B. The negative-electrode foil 221 includes a negative-electrode active material covered portion 221A and a negative-electrode active material non-covered portion 221B.

The negative-electrode active material layer 222 contains a negative-electrode active material that occludes and releases lithium as a negative-electrode active material. Here, the negative-electrode active material layer 222 may further include any one or more of other materials such as a negative electrode binder and a negative-electrode conductive agent.

Examples of the negative-electrode active material include a carbon material. In this case, since the change in the crystal structure at the time of occlusion and release of lithium is very small, a high energy density can be stably obtained. Further, the carbon material also serves as the negative-electrode conductive agent, which improves conductivity of the negative-electrode active material layer 222.

Examples of the carbon material used as the negative-electrode active material include graphitizable carbon, non-graphitizable carbon, and graphite. More specifically, the carbon material is, for example, pyrolytic carbons, cokes, glassy carbon fibers, organic polymer compound fired bodies, activated carbon, carbon blacks, and the like. Examples of the cokes include pitch coke, needle coke, and petroleum coke. The organic polymer compound fired body is obtained by firing (carbonizing) a polymer compound such as phenol resin or furan resin at an appropriate temperature. Here, when the non-graphitizable carbon is used, the interplanar spacing of the (002) plane of the non-graphitizable carbon is preferably 0.37 nm or more and 0.34 nm or less. Within this range, lithium can be suitably accumulated between carbon layers. In addition, the carbon material is not limited, and may be, for example, low crystalline carbon heat-treated at a temperature of about 1000° C. or less, or amorphous carbon. Further, it is to be noted that the shapes of the carbon materials may be any of fibrous, spherical, granular and scaly.

Here, the amounts of the positive-electrode active material and the negative-electrode active material are adjusted so that the open circuit voltage (that is, the battery voltage) at the time of full charge of the battery 1 is 4.25 V or more. As a result, as compared with a case where the open circuit voltage at the time of full charge is 4.20 V, the release amount of lithium per unit mass increases as well when the same positive-electrode active material is used, and thus a high energy density can be obtained.

The separator 23 is a film that electrically insulates the positive electrode 21 from the negative electrode 22. The material of the separator 23 is, for example, one or more of porous membranes such as synthetic resin and ceramics, and may be a layered membrane of two or more porous membranes. The synthetic resins may be, for example, polytetrafluoroethylene, polypropylene, polyethylene, and the like.

The separator 23 may include, for example, the above-described porous film or a stacked film of a porous film (hereinafter referred to as a substrate layer), and a polymer compound layer provided on one face or both faces of the substrate layer. The polymer compound layer contains, for example, a polymer compound such as a polyvinylidene fluoride. In this case, the physical strength of the separator 23 can be improved, and the chemical stability can be improved. The polymer compound layer is formed by, for example, applying a solution in which a polymer compound is dissolved in an organic solvent or the like to the substrate layer, and then drying the substrate layer. Here, in the formation of the polymer compound layer, the substrate layer may be immersed in a solution and then dried. By providing the polymer compound layer, the adhesion of the separator 23 to the positive electrode 21 and the negative electrode 22 is improved, and distortion of the electrode wound body 20 is suppressed, so that decomposition reaction of the electrolytic solution and leakage of the electrolytic solution from the substrate layer are suppressed. As a result, although charge and discharge are repeated, the resistance is less likely to increase, and battery swelling due to gas is suppressed. The material of the polymer compound layer is not limited thereto, and may contain insulating inorganic particles such as aluminum oxide and aluminum nitride.

In the example of the present embodiment, the positive-electrode active material non-covered portion 211B is softer than the negative-electrode active material non-covered portion 221B, that is, has a lower Young's modulus. Here, the width of the positive-electrode active material non-covered portion 211B is A, the width of the negative-electrode active material non-covered portion 221B is B, the length from one end of the positive-electrode active material non-covered portion 211B in the +Z direction to the end of the separator 23 in the Z direction is C, and the length from one end of the negative-electrode active material non-covered portion 221B in the −Z direction to the end of the separator 23 in the −Z direction is D. In this case, in the example of the present embodiment, A>B and C>D, for example, A=7 (mm), B=4 (mm), C=4.5 (mm), and D=3 (mm).

With this value, when the active material non-covered portions 211B and 221B are simultaneously bent at the same pressure from both electrode sides, the length in the Z direction from the end portion of the separator 23 in the +Z direction to the end portion 41 formed by bending the positive-electrode active material non-covered portion 211B and the length in the Z direction from the end portion of the separator 23 in the −Z direction to an end portion 42 formed by bending the negative-electrode active material non-covered portion 221B can be made substantially the same. As a result, the bent active material non-covered portions 211B and 221B can be appropriately overlapped.

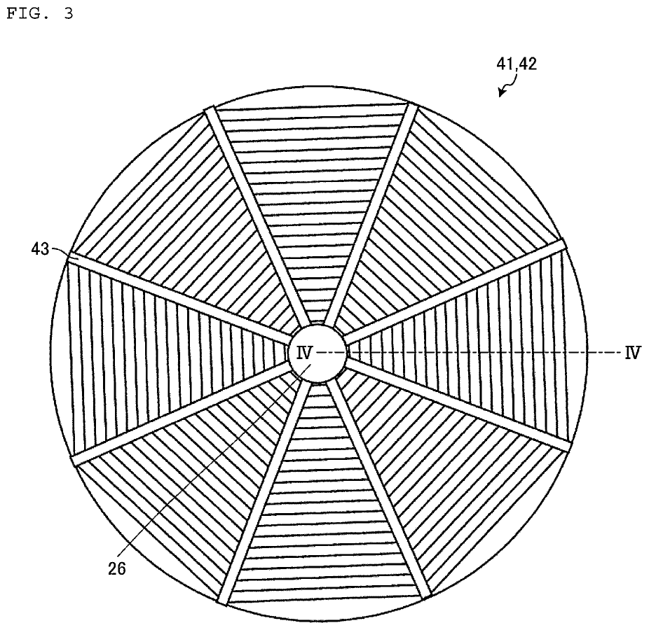

FIG. 3 is a plan view illustrating an end portion of the battery according to the present embodiment. The end portions 41 and 42 are surfaces formed by bending the active material non-covered portions 211B and 221B. That is, one end portion 41 of the electrode wound body 20 is an end portion including the positive-electrode active material non-covered portion 211B, and the other end portion 42 of the electrode wound body 20 is an end portion including the negative-electrode active material non-covered portion 221B. The end portions 41 and 42 are flat surfaces to such an extent as not to affect the bonding with the current collecting plates 30A and 30B.

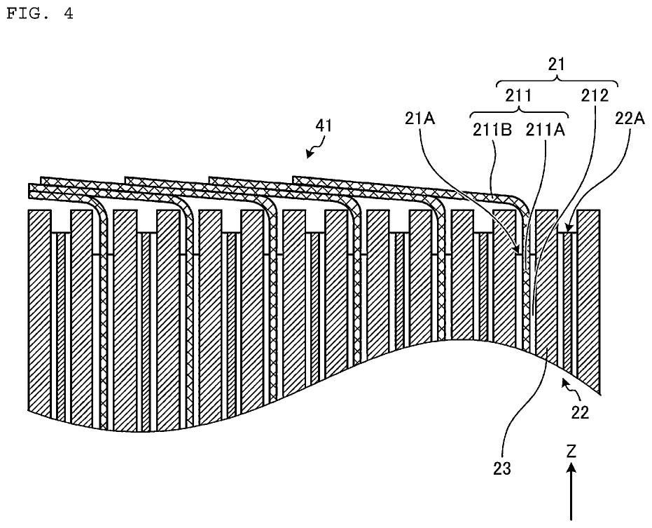

FIG. 4 is a diagram illustrating an example of a section taken along line IV-IV in FIG. 3. Hereinafter, the structure of the end portion 41 will be described in detail with reference to FIG. 4. As illustrated in FIG. 4, the end portion 41 is a surface formed by a positive-electrode active material non-covered portion 211B bent in the central axis direction. With this structure, the radiation (the radius of the electrode wound body) from the central axis, that is, a plurality of positive-electrode active material non-covered portions 211B on the line IV-IV has a structure stacked in the Z direction. With such a configuration, the positive electrode 21 is brought into contact with the positive-electrode current collecting plate 30A in a wide area and hence, a battery resistance can be lowered.

The end portion 42 has the same structure as the end portion 41. That is, as illustrated in FIG. 4, the end portion 42 is a surface formed with the negative-electrode active material non-covered portion 221B bent in the central axis direction. With this structure, a plurality of negative-electrode active material non-covered portions 221B on the radiation from the central axis has a structure stacked in the Z direction. Since the negative electrode 22 is brought into contact with the negative-electrode current collecting plate 30B in a wide area and hence, a battery resistance can be lowered.

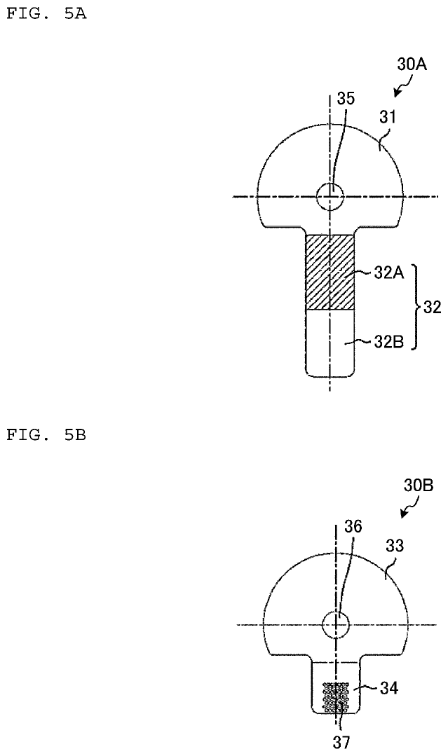

The end portions 41 and 42 are provided with a groove 43 as illustrated in FIG. 5B. The groove 43 extends from the outer peripheries of the end portions 41 and 42 to the through hole 26 in the central axis. The groove 43 is provided to prevent the end portions 41 and 42 from becoming a surface having many irregularities due to wrinkles or distortion of the positive-electrode active material non-covered portion 211B and the negative-electrode active material non-covered portion 221B at the time of bending the positive-electrode active material non-covered portion 211B and the negative-electrode active material non-covered portion 221B. As a result, it is possible to prevent deterioration in bondability between the end portions 41 and 42 and the current collecting plate, and it is possible to suppress resistance between the end portions 41 and 42 and the current collecting plates 30A and 30B.

More specifically, when the positive-electrode active material non-covered portion 211B and the negative-electrode active material non-covered portion 221B are bent without forming the groove 43 in the end portions 41 and 42 in advance, wrinkles or distortions may occur in the positive-electrode active material non-covered portion 211B and the negative-electrode active material non-covered portion 221B. On the other hand, when the groove 43 is formed in the end portions 41 and 42 in advance and then the positive-electrode active material non-covered portion 211B and the negative-electrode active material non-covered portion 221B are bent, generation of wrinkles at the time of bending can be suppressed. As a result, the end portions 41 and 42 can be flat surfaces with less irregularities.

FIG. 5A is a diagram illustrating a positive-electrode current collecting plate of the battery according to the present embodiment. The material of the positive-electrode current collecting plate 30A is, for example, a metal plate made of a simple substance of aluminum or an aluminum alloy, or a composite thereof. As illustrated in FIG. 5A, the positive-electrode current collecting plate 30A includes a fan-shaped portion 31 and a band-shaped portion 32.

The fan-shaped portion 31 is a part connected to the positive-electrode active material non-covered portion 211B. A hole 35 is provided in the fan-shaped portion 31. The fan-shaped portion 31 is provided between the end portion 41 and the insulating plate 12 in the battery 1. The fan-shaped portion 31 is welded to the end portion 41 at multiple points. Accordingly, the internal resistance of the battery can be suppressed. The bonding means between the positive-electrode current collecting plate 30A and the end portion 41 is not particularly limited, and is, for example, laser welding.

The hole 35 is provided at a position overlapping the through hole 26 in the Z direction when bonded to the end portion 41. With this structure, the electrolytic solution can be smoothly permeated into the electrode wound body 20 when the battery is assembled, and gas generated when the battery is in an abnormally high temperature state or an overcharged state can be easily released to the outside of the battery.

The band-shaped portion 32 is provided in a straight part of the fan-shaped portion 31. The band-shaped portion 32 includes an insulating portion 32A and a connection portion 32B. The band-shaped portion 32 is provided so as to penetrate insulating plate 12 in battery 1 in the Z direction. The insulating portion 32A is a part of the band-shaped portion 32 whose surface is covered with an insulator. An insulating tape is attached to the insulating portion 32A, or an insulating material is applied to the insulating portion. The insulating portion 32A is provided at a root of the band-shaped portion 32, that is, between the connection portion 32B and the fan-shaped portion 31. The connection portion 32B is a part where the connection portion 32B is connected to the safety valve mechanism 16. The connection portion 32B is provided at a tip of the band-shaped portion 32. When a center pin is not provided in the through hole 26, there is a low possibility that the band-shaped portion 32 comes into contact with a portion having a negative electrode potential, and thus the insulating portion 32A may not be provided. In this case, a width between the positive electrode 21 and the negative electrode 22 in the Z direction can be increased by an amount corresponding to a thickness of the insulating portion 32A, thereby increasing a charge and discharge capacity.

FIG. 5B is a diagram illustrating a negative-electrode current collecting plate of the battery according to the present embodiment. The material of the negative-electrode current collecting plate 30B is, for example, a metal plate formed with a simple substance nickel, a nickel alloy, copper, or a copper alloy, or a composite thereof. As illustrated in FIG. 5B, the negative-electrode current collecting plate 30B includes a fan-shaped portion 33 and a band-shaped portion 34.

The fan-shaped portion 33 is a part connected to the negative-electrode active material non-covered portion 221B. A hole 36 is provided in the fan-shaped portion 33. The fan-shaped portion 33 is provided between the end portion 42 and the insulating plate 13 in the battery 1. The negative-electrode current collecting plate 30B is bonded to the end portion 42 in the −Z direction. The fan-shaped portion 33 is welded to the end portion 42 at multiple points. The bonding means between the negative-electrode current collecting plate 30B and the end portion 42 is not particularly limited, and is, for example, laser welding. Accordingly, the internal resistance of the battery can be suppressed.

The hole 36 is provided at a position overlapping the through hole 26 in the Z direction when bonded to the end portion 42. With this structure, the electrolytic solution can be smoothly permeated into the electrode wound body 20 when the battery is assembled, and gas generated when the battery is in an abnormally high temperature state or an overcharged state can be easily released to the outside of the battery.

The band-shaped portion 34 is provided in a straight part of the fan-shaped portion 33. The band-shaped portion 34 is provided so as to penetrate insulating plate 13 in battery 1 in the Z direction. The band-shaped portion 34 of the negative-electrode current collecting plate 30B is shorter than the band-shaped portion 32 of the positive-electrode current collecting plate 30A. The band-shaped portion 34 is provided with a round protrusion portion (projection) 37 that is convex in the thickness direction. As a result, during resistance welding in the manufacturing process of the battery 1, since the protrusion portion 37 melts due to concentration of current, the band-shaped portion 34 can be welded to the closed portion of the exterior can 11.

The electrolytic solution according to the present embodiment contains a solvent and a solute. In the following description, the content of the electrolytic solution component in the battery 1 refers to the content in the electrolytic solution after the battery 1 is perfectly discharged. The content of the electrolytic solution component in the battery 1 can be determined by gas chromatography mass spectrometry or inductively coupled plasma emission spectrometry. As a gas chromatograph mass spectrometer, 5977B manufactured by Agilent Technologies was used. PS3500DDII manufactured by Hitachi High-Tech Corporation was used as an inductively coupled plasma atomic emission spectrometer.

The solvent includes a nonaqueous solvent such as an organic solvent. Examples of the nonaqueous solvent include cyclic carbonate esters such as ethylene carbonate (EC) and dymethyl carbonate (DMC), chain carbonate esters, lactones, chain carboxylate esters, and nitriles (mononitrile).

The solvent further includes fluoroethylene carbonate (FEC). By containing FEC, when a metal lithium layer is deposited on the surface of the negative electrode by charging in a low temperature environment, the metal lithium layer on the surface of the negative electrode is covered with a coating film made of a solvent-decomposed product, and deterioration of low temperature cycle characteristics can be suppressed. This is because the progress of precipitation of metallic lithium can be prevented by covering with the coating film.

The content of FEC in the battery 1 is 7.7 mass % or more with respect to the electrolytic solution. Within this range, the coating film having a thickness sufficient to cover the metal lithium layer can be obtained, so that deterioration of the low-temperature cycle characteristics can be sufficiently suppressed.

On the other hand, when FEC is excessively contained, generation of hydrogen fluoride (HF) is promoted when the temperature of the battery 1 rises. The hydrogen fluoride reacts with lithium carbonate (Li₂CO₃) or the like present on the surface of the positive electrode, so that a large amount of carbon dioxide gas or hydrocarbon gas may be generated. When a large amount of gas is generated and the internal pressure of the battery rises, the safety valve mechanism breaks and the current is cut off.

The content of FEC in the battery 1 is 11.5 mass % or less with respect to the electrolytic solution. Within this range, excessive generation of hydrogen fluoride (HF) can be suppressed, so that generation of gas can be suppressed.

The solute contains 14 mass % or more and 18 mass % of lithium hexafluorophosphate (LiPF₆).

The solute further includes lithium tetrafluoroborate (LiBF₄). By containing LiBF₄, a coating film is formed on the positive electrode, and contact between lithium carbonate present in the positive electrode and hydrogen fluoride in the electrolytic solution is suppressed, so that generation of carbon dioxide gas can be further suppressed.

The content of LiBF₄ in the battery 1 is 0.032 mass % or more with respect to the electrolytic solution. Within this range, the generation of carbon dioxide gas can be more sufficiently suppressed.

On the other hand, the content of LiBF₄ in the battery 1 is 0.048 mass % or less with respect to the electrolytic solution. Within this range, the coating film of the positive electrode becomes excessively thick, and an increase in battery resistance can be suppressed.

The solvent further contains succinonitrile (SN). By containing SN, the SN collects metal ions in the electrolytic solution, so that the battery 1 can be prevented from being short-circuited. Hereinafter, a mechanism in which SN suppresses short circuit of the battery 1 will be described in detail with reference to FIG. 4.

In the battery 1 according to the present embodiment, as illustrated in FIG. 4, since the positive-electrode active material non-covered portion 211B is bent in the central axis direction, the positive-electrode active material covered portion 211A in the vicinity of the end portion 41 is also pulled in the central axis direction, and there may be a difference in the layer interval between the adjacent positive electrode and negative electrode. More specifically, since the negative electrode 22 is disposed outside the positive electrode 21 on the outermost periphery of the electrode wound body 20, a local increase in layer spacing may occur between the upper end 21A of the positive electrode 21 in the outermost peripheral portion of the electrode wound body 20 and the upper end 22B of the negative electrode 22 in the outermost peripheral portion of the electrode wound body 20. Here, the upper end 21A of the positive electrode 21 refers to an end portion of the positive-electrode active material covered portion 211A and the positive-electrode active material layer 212 in the +Z direction, and an upper end 22A of the negative electrode 22 in the +Z direction refers to an end portion of the negative electrode 22 in the +Z direction, that is, the negative-electrode active material covered portion 221A and the negative-electrode active material layer 222.

As a result, the potential of the positive electrode 21 increases, and when the potential of the positive electrode 21 becomes equal to or higher than the dissolution potential of the transition metal (for example, nickel) in the positive-electrode active material, the transition metal in the positive-electrode active material is eluted into the electrolytic solution. When SN is not contained in the electrolytic solution, metal ions eluted in the electrolytic solution may be precipitated on the surface of the negative electrode 22. At this time, if a precipitate penetrates the separator 23, the precipitate may reach the positive electrode 21 and cause a short circuit. On the other hand, when SN is contained in the electrolytic solution, it is considered that SN collects metal ions in the electrolytic solution to form a complex containing the metal ions, and does not precipitate on the surface of the negative electrode 22. As described above, since the electrolytic solution contains SN, deposition of metal ions in the electrolytic solution on the surface of the negative electrode 22 can be prevented, so that the short-circuiting of the battery can be prevented.

The content of SN in the battery 1 is 0.392 mass % or more with respect to the electrolytic solution. Within this range, SN can sufficiently collect metal ions in the electrolytic solution, so that the short-circuiting of the battery 1 can be suppressed.

On the other hand, the content of SN in the battery 1 is 0.588 mass % or less with respect to the electrolytic solution. Within this range, the coating film on the surface of the negative electrode 22 becomes excessively thick, and an increase in battery resistance can be suppressed.

The solute of the electrolytic solution is not limited to the solutes mentioned above, and may include, for example, electrolyte salts such as lithium tetraphenylborate (LiB(C₆H₅)₄), Lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), lithium bromide (LiBr), and the like.

As described above, the battery 1 according to the present embodiment includes components housed in the exterior can 11, the components including: the electrode wound body 20 having a structure in which the band-shaped positive electrode 21 including the positive-electrode foil 211 and the positive-electrode active material layer 212 and the band-shaped negative electrode 22 including the negative-electrode foil 221 and the negative-electrode active material layer 222 are stacked with the separator 23 interposed therebetween and wound around a central axis; the positive-electrode current collecting plate 30A; the negative-electrode current collecting plate 30B; and the electrolytic solution, in which the positive-electrode foil 211 has the positive-electrode active material covered portion 211A covered with the positive-electrode active material layer 212 and the positive-electrode active material non-covered portion 211B not covered with the positive-electrode active material layer 212, the negative-electrode foil 221 includes the negative-electrode active material covered portion 221A covered with the negative-electrode active material layer 222 and the negative-electrode active material non-covered portion 221B not covered with the negative-electrode active material layer 222, a surface (end portion 41) on which the positive-electrode active material non-covered portion 211B bent toward the central axis overlaps and the positive-electrode current collecting plate 30A are bonded to each other, a surface (end portion 42) on which the negative-electrode active material non-covered portion 221B bent toward the central axis overlaps and the negative-electrode current collecting plate 30B are bonded to each other, and the electrolytic solution contains 7.7 mass % or more and 11.5 mass % or less of fluoroethylene carbonate (FEC), 0.032 mass % or more and 0.048 mass % or less of lithium tetrafluoroborate (LiBF₄), and lithium hexafluorophosphate (LiPF₆).

As a result, the positive electrode 21 and the negative electrode 22 have the active material non-covered portions 211B and 221B that are not covered with the active material layers 212 and 222, and the active material non-covered portions 211B and 221B are bonded to the current collecting plates 30A and 30B at the end portions 41 and 42 of the electrode wound body 20, and are bent and overlapped with each other toward the central axis of the wound structure, so that the internal resistance of the battery can be reduced as compared with a normal battery in which a lead for current extraction is welded to each of the positive electrode 21 and the negative electrode 22. As a result, it is possible to prevent the battery from generating heat and reaching a high temperature at the time of discharge, and thus, it is possible to perform high rate discharge. In addition, by setting the amount of FEC within the range of the present disclosure, the cycle characteristics in a low temperature environment can be improved without excessively generating gas, and by setting the amount of LiBF₄ within the range of the present disclosure, gas generation due to decomposition of FEC can be suppressed while an increase in resistance is suppressed. This makes it possible to improve the cycle characteristics in a low temperature environment while suppressing generation of gas and an increase in resistance.

As a desirable aspect, the electrolytic solution further contains 0.392 mass % or more and 0.588 mass % or less of succinonitrile (SN). As a result, since SN collects metal ions in the electrolytic solution and accumulates the metal ions on the surface of the negative electrode 22, it is possible to suppress a short circuit of the battery due to deposition of the transition metal while suppressing an increase in the battery resistance.

### EXAMPLES

Hereinafter, examples will be described according to an embodiment. The present disclosure is not limited to Examples described below.

Table 1 is a table showing the measurement results of the batteries according to Test Example 1-1 to Test Example 1-7.

TABLE 1

| | | | | Number of | High- | |
|---|---|---|---|---|---|---|
| | | | | low- | temperature | |
| | FEC | LiBF₄ | SN | temperature | cutoff time | |
| | (Mass %) | (Mass %) | (Mass %) | cycles | (h) | Evaluation |
| Test Example | 12.0 | 0.040 | 0.49 | 800 | 20 | B |
| 1-1 | | | | | | |
| Test Example | 11.5 | 0.040 | 0.49 | 750 | 100 | A |
| 1-2 | | | | | | |
| Test Example | 10.4 | 0.040 | 0.49 | 700 | 150 | A |
| 1-3 | | | | | | |
| Test Example | 9.6 | 0.040 | 0.49 | 600 | 150 | A |
| 1-4 | | | | | | |
| Test Example | 8.6 | 0.040 | 0.49 | 550 | 150 | A |
| 1-5 | | | | | | |
| Test Example | 7.7 | 0.040 | 0.49 | 500 | 170 | A |
| 1-6 | | | | | | |
| Test Example | 7.6 | 0.040 | 0.49 | 300 | 175 | B |
| 1-7 | | | | | | |

### Test Example 1-1

The battery according to Test Example 1-1 was produced by the following method.

The positive-electrode active material was coated on a portion of the surface of the positive-electrode foil 211 to provide a positive-electrode active material covered portion 211A and a positive-electrode active material non-covered portion 211B. Similarly, the negative-electrode active material was coated on a portion of the surface of the negative-electrode foil 221 to provide a negative-electrode active material covered portion 221A and a negative-electrode active material non-covered portion 221B. At this time, a cut-out was provided in a part of the active material non-covered portions 211B and 221B corresponding to the central axis.

Then, the positive electrode 21 and the negative electrode 22, which had been subjected to pretreatment such as drying, were stacked with the separator 23 interposed therebetween, and spirally wound so as to form the through hole 26 in the central axis, thereby producing an electrode wound body 20.

Next, a load was locally applied to the end portions 41 and 42 formed by winding the active material non-covered portions 211B and 221B to form the groove 43. Then, a load was applied from the outer circumferential direction of the end portions 41 and 42 so that the active material non-covered portions 211B and 221B were bent toward the through hole 26 side. Then, the same pressure was simultaneously applied to the active material non-covered portions 211B and 221B from both sides in the Z direction, and the end portions 41 and 42 were formed to be flat surfaces. Thereafter, the fan-shaped portion 31 of the positive-electrode current collecting plate 30A was subjected to laser welding to the end portion 41, and the fan-shaped portion 33 of the negative-electrode current collecting plate 30B was subjected to laser welding to the end portion 42.

Thereafter, the band-shaped portions 32 and 34 of the current collecting plates 30A and 30B were bent, and the insulating plates 12 and 13 were attached to the positive-electrode current collecting plate 30A and the negative-electrode current collecting plate 30B, respectively. The electrode wound body 20 assembled in the above steps was inserted into the exterior can 11, and the bottom of the exterior can 11 was welded. An electrolytic solution was injected into the exterior can 11, and then sealing was performed with a gasket 15 and a battery lid 14.

Here, as a result of analyzing the collected electrolytic solution by perfectly discharging the battery according to Test Example 1-1 produced and then making a hole in the exterior can 11 and subjecting the battery to a centrifuge, the contents of FEC, LiBF₄, and SN were as shown in Table 1. Here, the contents of other components shown in Table 1 in the electrolytic solution according to Test Example 1-1 were 11.4 mass % for EC, 59.87 mass % for DMC, and 16.2 mass % for LiPF₆. The electrolytic solution was analyzed by a gas chromatography mass spectrometer.

### Test Example 1-2 to Test Example 1-7

The batteries according to Test Example 1-2 to Test Example 1-7 were produced by performing the same operations as in Example 1-1 except that the content of FEC of the electrolytic solution was adjusted to be the content shown in Table 1. Among the components of the electrolytic solutions according to Test Example 1-2 to Test Example 1-7, the contents of other components shown in Table 1 were adjusted so that the mass ratio of (EC+FEC):DMC and the molar concentration (mol/kg) of LiPF₆ were the same as those of the electrolytic solution according to Test Example 1-1.

The number of low-temperature cycles of the produced batteries according to Test Example 1-1 to Test Example 1-7 was measured. The number of low-temperature cycles was defined as the number of times of charge and discharge when the charge and discharge capacity of the battery became less than 40% at the time of initial charge and discharge for the first time, and the measurement was performed under the following conditions. Charging was performed by a CCCV method, and charging was performed until the current became equal to the charge cutoff current. In addition, discharging was performed by a CC method, and discharging was performed until the voltage reached a discharge cutoff voltage.
Measurement temperature: 0° C.
Charge voltage: 4.2 V
Charge current: 6.5 A
Charge cutoff current: 0.1 A
Discharge current: 15 A
Discharge cutoff voltage: 2.5 V
Time to rest between charge and discharge: 30 min

For the produced batteries according to Test Example 1-1 to Test Example 1-7, a high-temperature cutoff time was measured. The high-temperature cutoff time was measured by leaving the battery in a thermostat at 80° C. Here, the high-temperature cutoff time was a time from when the battery was placed in a thermostat until the safety valve mechanism 16 was broken.

In the batteries according to Test Example 1-1 to Test Example 1-7, the battery having the number of low-temperature cycles of 500 times or more and the high-temperature cutoff time of 100 hours or more was evaluated as pass (evaluation A), and the other batteries were evaluated as fail (evaluation B).

As shown in Table 1, Test Example 1-2 to Test Example 1-6, which are Examples, were evaluated as pass because the number of low-temperature cycles was 500 times or more and the high-temperature cutoff time was 100 hours or more. It can be seen that the batteries according to Test Example 1-2 to Test Example 1-6 can improve the number of low-temperature cycles while suppressing the generation of gas. On the other hand, in Test Example 1-1 as a comparative example, since the high-temperature cutoff time was 20 hours, it was determined as fail. It can be seen that in the battery according to Test Example 1-1, since FEC is excessively contained, generation of gas cannot be suppressed. Test Example 1-7, which is a comparative example, failed because the low temperature cycle was 300 times. It can be seen that the battery according to Test Example 1-7 cannot improve the cycle characteristics at low temperature because the FEC is insufficient.

Table 2 is a table showing the measurement results of the batteries according to Test Example 2-1 to Test Example 2-7.

TABLE 2

| | | | | | Storage | |
|---|---|---|---|---|---|---|
| | | | | Battery | resistance | |
| | FEC | LiBF₄ | SN | resistance | time | |
| | (Mass %) | (Mass %) | (Mass %) | (mΩ) | (h) | Evaluation |
| Test Example | 9.6 | 0.050 | 0.490 | 6.9 | 780 | B |
| 2-1 | | | | | | |
| Test Example | 9.6 | 0.048 | 0.490 | 5.5 | 750 | A |
| 2-2 | | | | | | |
| Test Example | 9.6 | 0.044 | 0.490 | 5.3 | 730 | A |
| 2-3 | | | | | | |
| Test Example | 9.6 | 0.040 | 0.490 | 4.8 | 700 | A |
| 2-4 | | | | | | |
| Test Example | 9.6 | 0.036 | 0.490 | 4.6 | 680 | A |
| 2-5 | | | | | | |
| Test Example | 9.6 | 0.032 | 0.490 | 4.4 | 600 | A |
| 2-6 | | | | | | |
| Test Example | 9.6 | 0.030 | 0.490 | 4.3 | 400 | B |
| 2-7 | | | | | | |

### Test Example 2-1 to Test Example 2-7

Batteries according to Test Example 2-1 to Test Example 2-7 were produced by performing the same operations as in Example 1-1 except that the contents of FEC and LiBF₄ in the electrolytic solution were adjusted to be the contents shown in Table 2. Among the components of the electrolytic solutions according to Test Example 2-1 to Test Example 2-7, the contents of other components shown in Table 2 were adjusted so that the mass ratio of (EC+FEC): DMC and the molar concentration (mol/kg) of LiPF₆ were the same as those of the electrolytic solution according to Test Example 1-1.

The battery resistance of the produced batteries according to Test Example 2-1 to Test Example 2-7 was measured. The battery resistance was determined by measuring the AC impedance of the produced battery at 1 KHz at a voltage of 3.35 V to 3.55 V. The battery resistance was measured using a battery high tester 3561 manufactured by HIOKI E.E. Corporation.

For the produced batteries according to Test Example 2-1 to Test Example 2-7, storage resistance time was measured. The storage resistance time was measured by leaving the produced battery at a high temperature of 60° C. in a fully charged state. Here, the time from when the battery was placed in a thermostatic bath at 60° C. until the voltage dropped below 4.0 V due to a short circuit was defined as the storage resistance time.

In the batteries according to Test Examples 2-1 to 2-7, the battery having a battery resistance of 6.2 mΩ or less and a storage resistance time of 600 hours or more was evaluated as pass (evaluation A), and the other batteries were evaluated as fail (evaluation B).

As shown in Table 2, Test Example 2-2 to Test Example 2-6, which are Examples, were evaluated as pass because the battery resistance was 6.2 mΩ or less and the storage resistance time was 600 hours or more. It can be seen that the batteries according to Test Example 2-2 to Test Example 2-6 can improve the storage resistance time while suppressing an increase in battery resistance. On the other hand, in Test Example 2-1 as a comparative example, since the battery resistance was 6.9 mΩ, it was determined as fail. It can be seen that in the battery according to Test Example 2-1, since LiBF₄ is excessively contained, the resistance increases. Further, Test Example 2-7, which is a comparative example, was rejected because the storage resistance time was 400 hours. It can be seen that in the battery according to Test Example 2-7, the storage time is short because LiBF₄ is insufficient.

Table 3 is a table showing the measurement results of the batteries according to Test Example 3-1 to Test Example 3-7.

TABLE 3

| | | | | | Storage | |
|---|---|---|---|---|---|---|
| | | | | Battery | resistance | |
| | FEC | LiBF₄ | SN | resistance | time | |
| | (Mass %) | (Mass %) | (Mass %) | (mΩ) | (h) | Evaluation |
| Test Example | 9.6 | 0.040 | 0.593 | 7.4 | 780 | B |
| 3-1 | | | | | | |
| Test Example | 9.6 | 0.040 | 0.588 | 6.2 | 750 | A |
| 3-2 | | | | | | |
| Test Example | 9.6 | 0.040 | 0.516 | 5.3 | 730 | A |
| 3-3 | | | | | | |
| Test Example | 9.6 | 0.040 | 0.490 | 4.8 | 700 | A |
| 3-4 | | | | | | |
| Test Example | 9.6 | 0.040 | 0.438 | 4.7 | 680 | A |
| 3-5 | | | | | | |
| Test Example | 9.6 | 0.040 | 0.392 | 4.5 | 660 | A |
| 3-6 | | | | | | |
| Test Example | 9.6 | 0.040 | 0.387 | 4.4 | 500 | B |
| 3-7 | | | | | | |

### Test Example 3-1 to Test Example 3-7

Batteries according to Test Example 3-1 to Test Example 3-7 were produced by performing the same operations as in Example 1-1 except that the contents of FEC and SN of the electrolytic solution were adjusted to be the contents shown in Table 3. Among the components of the electrolytic solutions according to Test Example 3-1 to Test Example 3-7, the contents of other components shown in Table 3 were adjusted so that the mass ratio of (EC+FEC): DMC and the molar concentration (mol/kg) of LiPF₆ were the same as those of the electrolytic solution according to Test Example 1-1.

For the produced batteries according to Test Example 3-1 to Test Example 3-7, the battery resistance and the storage resistance time were measured in the same manner as in Test Example 2-1 to Test Example 2-7.

In the batteries according to Test Examples 3-1 to 3-7, the battery having a battery resistance of 6.2 mΩ or less and a storage resistance time of 600 hours or more was evaluated as pass (evaluation A), and the other batteries were evaluated as fail (evaluation B).

As shown in Table 3, Test Example 3-2 to Test Example 3-6, which are Examples, were evaluated as pass because the battery resistance was 6.2 mΩ or less and the storage resistance time was 600 hours or more. It can be seen that the batteries according to Test Example 3-2 to Test Example 3-6 can improve the storage resistance time while suppressing an increase in battery resistance. On the other hand, in Test Example 3-1 as a comparative example, since the battery resistance was 7.4 mΩ, it was determined as fail. It can be seen that in the battery according to Test Example 3-1, since SN is excessively contained in the electrolytic solution, the resistance increases. Further, Test Example 3-7, which is a comparative example, was rejected because the storage resistance time was 500 hours. It can be seen that in the battery according to Test Example 3-7, the storage time is short because SN is insufficient.

Note that the embodiments described above are intended to facilitate understanding of the present disclosure, but not intended to construe the present disclosure in any limited way. The present disclosure may be modified/improved without departing from the spirit thereof, and the present disclosure includes equivalents thereof.

For example, the battery 1 according to another embodiment of the present disclosure includes components housed in the exterior can 11, the components including: the electrode wound body 20 having a structure in which the band-shaped positive electrode 21 including the positive-electrode foil 211 and the positive-electrode active material layer 212 and the band-shaped negative electrode 22 including the negative-electrode foil 221 and the negative-electrode active material layer 222 are stacked with the separator 23 interposed therebetween and wound; the positive-electrode current collecting plate 30A; the negative-electrode current collecting plate 30B; and the electrolytic solution, in which the positive-electrode foil 211 has the positive-electrode active material covered portion 211A covered with the positive-electrode active material layer 212 and the positive-electrode active material non-covered portion 211B not covered with the positive-electrode active material layer 212, the negative-electrode foil 221 includes the negative-electrode active material covered portion 221A covered with the negative-electrode active material layer 222 and the negative-electrode active material non-covered portion 221B not covered with the negative-electrode active material layer 222, the positive-electrode active material non-covered portion 211B is bonded to the positive-electrode current collecting plate 30A at one end portion 41 of the electrode wound body 20, the negative-electrode active material non-covered portion 221B is bonded to the negative-electrode current collecting plate 30B at the other end portion 42 of the electrode wound body 20, the one end portion 41 has an overlapping surface formed by the positive-electrode active material non-covered portion 211B bent toward the central axis of the wound structure, the other end portion 42 has an overlapping surface formed by the negative-electrode active material non-covered portion 221B bent toward the central axis of the wound structure, and the electrolytic solution contains further contains 0.392 mass % or more and 0.588 mass % or less of succinonitrile (SN). As a result, since SN collects metal ions in the electrolytic solution and does not precipitate the metal ions on the surface of the negative electrode 22, it is possible to suppress a short circuit of the battery due to deposition of the transition metal while suppressing an increase in the battery resistance.

### DESCRIPTION OF REFERENCE SYMBOLS

1: Battery
11: Exterior can
11N: Open end portion
11P: Bent portion
11R: Crimped structure
12, 13: Insulating plate
14: Battery lid
15: Gasket
16: Safety valve mechanism
20: Electrode wound body
21: Positive electrode
21A: Upper end
211: Positive-electrode foil
212: Positive-electrode active material layer
211A: Positive-electrode active material covered portion
211B: Positive-electrode active material non-covered portion
213: Insulating layer
22: Negative electrode
22A: Upper end
221: Negative-electrode foil
222: Negative-electrode active material layer
221A: Negative-electrode active material covered portion
221B: Negative-electrode active material non-covered portion
23: Separator
26: Through hole
30A: Positive-electrode current collecting plate
30B: Negative-electrode current collecting plate
31: Fan-shaped portion
32: Band-shaped portion
32A: Insulating portion
32B: Connection portion
33: Fan-shaped portion
34: Band-shaped portion
35, 36: Pore
37: Protrusion portion
41, 42: End portion
43: Groove

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising components housed in an exterior can, the components including:
an electrode wound body having a structure in which a band-shaped positive electrode including a positive-electrode foil and a positive-electrode active material layer and a band-shaped negative electrode including a negative-electrode foil and a negative-electrode active material layer are stacked with a separator interposed therebetween and wound around a central axis;
a positive-electrode current collecting plate;
a negative-electrode current collecting plate; and
an electrolytic solution,
wherein the positive-electrode foil has a positive-electrode active material covered portion covered with the positive-electrode active material layer and a positive-electrode active material non-covered portion not covered with the positive-electrode active material layer,
the negative-electrode foil includes a negative-electrode active material covered portion covered with the negative-electrode active material layer and a negative-electrode active material non-covered portion not covered with the negative-electrode active material layer,
a surface on which the positive-electrode active material non-covered portion bent toward the central axis overlaps and the positive-electrode current collecting plate are bonded to each other,
a surface on which the negative-electrode active material non-covered portion bent toward the central axis overlaps and the negative-electrode current collecting plate are bonded to each other, and
the electrolytic solution contains 7.7 mass % or more and 11.5 mass % or less of fluoroethylene carbonate, 0.032 mass % or more and 0.048 mass % or less of lithium tetrafluoroborate, and lithium hexafluorophosphate.

2. The battery according to claim 1, wherein the electrolytic solution further contains 0.392 mass % or more and 0.588 mass % or less of succinonitrile.
